(19) United States
(12) Patent Application Publication
(10) Pub. No.: US 2017/0116649 A1
(43) Pub. Date: Apr. 27, 2017

(54) Systems and Methods for Dynamic Creation of Customized Image

(71) Applicant: Andrew Phillip Gordon, Brookline, MA (US)

(72) Inventor: Andrew Phillip Gordon, Brookline, MA (US)

(21) Appl. No.: 15/332,799

(22) Filed: Oct. 24, 2016

Related U.S. Application Data
(60) Provisional application No. 62/245,124, filed on Oct. 22, 2015.

(51) Int. Cl. G06Q 30/02; G06F 17/30

(52) U.S. Cl. CPC G06Q 30/0276; G06F 17/30265

(57) ABSTRACT

An innovative system and method that dynamically creates images for use in advertising from available inventory, current pricing and incentives, and optionally custom defined advertisements. The image may contain, without limitation, one or more payments, one or more interest rate, and one or more sale prices, as well as an optional disclaimer for qualifying the terms of the advertisement.

### BACKGROUND

Managing current incentives and offers is a very time-consuming and error-prone process for automobile dealers and manufacturers. There are many factors that often affect the specials or incentives offered on a dealer website. These ever changing factors require the website to be constantly monitored and updated. Given that web site traffic offers a high impact area of advertising, the maintenance effort required to maintain currency is a major deterrent from keeping the site up to date. Furthermore, there is often a lengthy delay after new rebates and rates are released from manufacturers and banks before manufacturers and dealers can post specials to their website. This delay is due to the time requires to calculate, generate, and verify all of the information in the specials, and this task happens at a very busy time in the dealership world. This is lost time, and it costs the dealership or manufacturer sales against the competition.

Once a special or promotion is created, the title, content, and disclaimer of the special need to be sent to a designer or design team to make the creative that will be published. The creative may be a mix of HTML, images, PDF documents, videos and other content that will be formatted and distributed to potential customers. Transcription errors often occur during this step as each special includes important details like term, stock number, and expiration date. Developing the creative materials also takes a significant amount of time and requires someone with specialized knowledge of design software to transcribe and create the promotional content.

A further impediment exists in ensuring the content of the advertisement conforms to advertising standards set forth by the manufacturer. Manufacturers often set guidelines and requirements of how their products, or any promotions of those products, may be presented in promotional materials. If the advertisement does not comport with the manufacturer's guidelines, manufactures and/or government agencies may impose steep penalties and fines for not meeting applicable brand or legal standards.

Once content is created, the content then has to be distributed to the appropriate sources. A common example in the automotive sales industry is a dealer updating a website's homepage slider with images that show their latest lease or finance specials. A slider may comprise a banner or other framed portion of the webpage with which a user may interact. The images in the slider may be subject to an expiration date, by which date the vehicle may no longer be offered, or subject to a given promotion. It is extremely cumbersome to start the entire publishing process over again to update scenarios in which vehicles used in specials are sold or the specials for a dealer change based on updated programs.

The automotive sales industry is extremely competitive, and all parties would benefit from having a system or mechanism to create and offer promotional specials that may be updated and maintained with minimal effort. Everyone benefits when promotional information is updated in a faster manner with more accurate information and kept up to date automatically.

Specifically, dealers and manufacturers would benefit from an innovative system and method that dynamically creates images for use in advertising from available inventory, current pricing and incentives, and optionally custom defined advertisements that can be linked from the same URL or website.

Website specials and banners at car dealerships need to be updated as incentives, pricing, and inventory changes. In a typical environment, the current process in promotional creation and maintenance relies on Sales Managers (“SM”) at the car dealership to analyze their inventory and the current incentives to determine which vehicles to advertise. The SM may also calculate vehicle payments like leases or balloon payments to use in their advertising. The SM then sends this information to an advertising agency, graphic designer, or other agent for placement in advertising images. Once the advertising images are created, they are sent back to the dealership to be used in marketing capacities including, but not limited to, dealership websites and emails to customers. The entire process can take multiple days, and often is not completed during a given month due to the amount of time and effort required.

### SUMMARY

Embodiments of the present invention described herein are not solely limited to the precise implementations described. One of ordinary skill in the art would recognize that the implementation of the systems and methods described herein may vary in the specific implementations without deviating from the scope and spirit of the invention. The terminology used in the description is for the purpose of describing the particular versions or embodiments only, and is not intended to limit the scope.

In an embodiment of the present invention, a dynamic advertising image creation system may include a processor and a non-transitory, computer readable storage medium in operable communication with the processor. The computer-readable storage medium may contain one or more programming instructions that, when executed, cause the processor to access at least one entity system, the at least one entity system comprising a plurality of vehicles inventory information gathered from inventory feed information or configuration data about vehicles, manufacturer rebate and incentive information compiled through the use of 3rd party information, manufacturer relationships, and/or dealer information, banks and lending institution available interest rates, credit tiers, and other payment specific information, dealer configuration profiles through the use of smart defaults and overrides configured by the dealership, manufacturer specific disclaimer information including disclosures configured per the manufacturer and financial institution lender agreements, state specific disclosures to conform to state specific rules and regulations, and design template information based on the current profile settings for the image to be generated.

In one aspect, the entity may be a dealership seeking to update a website or automating a marketing campaign. In another aspect, the entity may be a manufacturer seeking to update their advertising to include, without limitation, better, faster, and/or more specific regional coverage.

Embodiments of the present invention include innovative systems and methods for automating the selection of a vehicle. The embodiment uses vehicle feed information from the dealer to select the most optimal vehicles to advertise. This can follow a variety of algorithms, including, but not limited to, selecting the lowest priced vehicle of a particular model, the oldest vehicles of a particular model, or the vehicle with the highest likelihood of aging.

Embodiments of the present invention include innovative systems and methods for automatically calculating payments and relevant purchase details using vehicle, incentive, and pricing information. The embodiment uses feeds and compiled data to capture all of the necessary data points used inside a dealership to calculate promotional payments, annual percentage rates (“APRs”), rebate information, and vehicle pricing. This information may be compiled into the appropriate lender formulas to generate payments and deals with a configuration including smart default and dealer configuration overrides.

Embodiments of the present invention include innovative systems and methods for creating images from source content dynamically. In one aspect, the promotion can be rendered in text form of HTML, which is then rendered in a headless browser and captured in image format to dynamically create images from text content. In another aspect, the promotion can be rendered through assistant libraries using programming languages to dynamically create an image from selecting an image in memory and combining a mixture of images and dynamic text to create a new customized image unique to the given promotion.

Embodiments of the present invention further include innovative systems and methods for maintaining current, unexpired, and accurate advertisements. In one embodiment, the system monitors the currently offered promotions to determine if circumstantial configurations concerning that promotion have changed. Examples of potential changes include, without limitation, dealer defaults, sold status of vehicles, current incentives, or pricing. Specials that are found to be out of date are deleted and the automated system can recreate new specials based on the current relevant information.

Further embodiments of the present invention include innovative systems and methods for ensuring that custom defined advertisements and automated advertisements are combined appropriately. In this embodiment, the system allows a dealer to configure their own specials and seamlessly integrate custom advertisements into the mix of automated advertisements to create a rich and complete advertising experience.

Embodiments of the present inventory also include innovative systems and methods for ensuring that delivered content is current and up to date by bi-directional communication with a caching system. In one embodiment, the system caches requests for images to decrease response time and improve the customer experience. The system that manages the current specials may have the ability to prematurely expire the cache if it determines that the content that should be delivered has changed.

According to another embodiment of the invention, a system, method and computer programmable medium for dynamically generating a customized image file to promote a product is disclosed. The illustrative system includes a processor, an image database, a pricing databank, an incentive databank, and a promotional database comprising a plurality of promotional templates. The illustrative embodiment is further configured to receive a generation request for at least one customized image and select a promotional template from the promotional database, the promotional template comprising input criteria for determination of a promotional offer. Either pricing or incentive information, or both is extracted from their respective databanks and is input into the input criteria of the promotional template to generate the promotional offer. The promotional offer reflects the information extracted from the pricing and/or incentive databanks. At least one original image is retrieved from the image database according to the pricing information and the customized image is rendered from the original image and the promotional offer into a format for display in a web browser. The customized image comprising the promotional offer.

### BRIEF DESCRIPTION OF THE DRAWINGS

Embodiments of the present invention will be more readily understood from a detailed description of the preferred embodiments taken in conjunction with the following figures:

FIG. 1 illustrates an exemplary flowchart of a traditional process of promotional image creation;

FIG. 2 illustrates an exemplary flowchart of a process of promotional image creation in accordance with one embodiment of the invention;

FIG. 3A illustrates an exemplary flowchart of a process of promotional image creation in accordance with one embodiment of the invention;

FIG. 3B illustrates an exemplary customized promotional image in accordance with one embodiment of the invention; and

FIG. 4 illustrates a block diagram of exemplary internal hardware, in accordance with one embodiment of the invention.

### DETAILED DESCRIPTION

In the following description, numerous specific details presented in order to provide a comprehensive understanding of the present invention. It may be apparent to one skilled in the art that the present invention may be practiced with or without some or all of these specific details, however, in other instances, well known process operations have not been described in detail in order not to unnecessarily obscure the embodiments of the present invention.

As used in this document, the singular forms “a”, “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

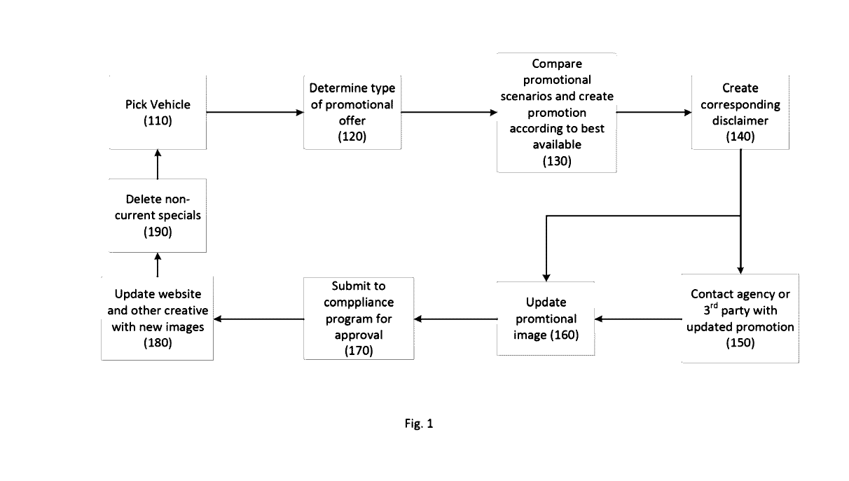

Turning now to FIG. 1, a high level overview of the traditional process 100 to add Specials Banners to a dealership's marketing materials is depicted. The process starts with a sales manager or other highly trained individual picking out the right models and possibly stock numbers to advertise 110. The SM then calculates payments, down payments, and amounts due at signing on that vehicle for lease, finance, or balloon 120. This person might also calculate discounts, sale prices, finance APR's, and other incentives to promote vehicles 130. The manager and/or 3rd party manually also produce the necessary disclaimers to comply with advertising rules and laws 140. Once this information has been compiled, the manager then either sends this information to a 3rd party marketing firm 150 which compiles these advertisements as part of the dealership's creative or manually updates the marketing materials 160 herself. The manager may then submit this material to the manufacturer to check for compliance with advertising guidelines 170. The manager and/or 3rd party then upload the creative to the appropriate place on the website, perhaps with an expiration date 180. If the specials, pricing, incentives, rates, or available vehicles for the special change, the managers must manually remember to check this and start the process over again with the new specials 190.

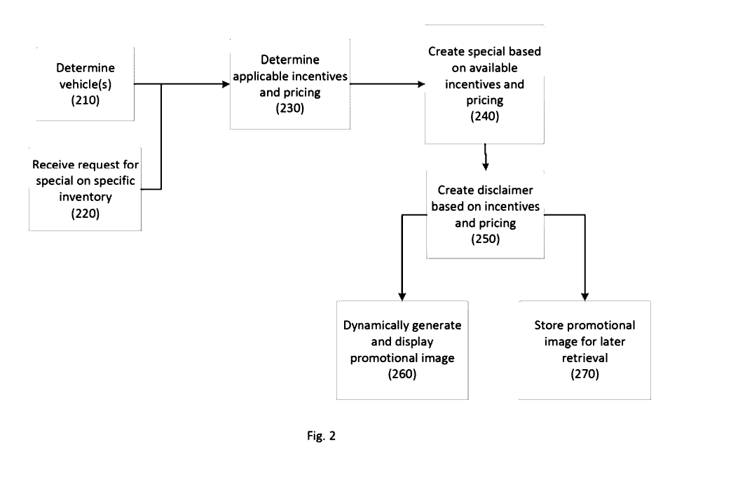

Turning now to FIG. 2, a process flow 200 for an image created with one of the embodiments of the invention is depicted. One embodiment of the Specials Image Creation (“SIC”) includes creating promotional offers or specials of varying types based on pricing data and incentive data. According to one embodiment of the invention, pricing data may include, but is not limited to, inventory, interest rates, inventory, MSRP, taxes fees and other input factors used in determining a price or payment for a product. This includes determining the best vehicles to advertise, the best available payments, and the best rates. According to one embodiment, incentive data may include, but is not limited to, discounts, rebates, selective financing, or other enticements that are intended to motivate a customer to obtaining a product.

One embodiment of the invention includes the process to determine the optimal vehicles to use in the special 210. Programming instructions search through pricing data, such as an available feed of inventory or vehicle data using the appropriate configuration and algorithm 230. Alternatively, a vehicle may be chosen or found that is outside of a current seller's inventory, but may be otherwise available. The search algorithm may take into account a variety of factors that include, but are not limited to, vehicle age, vehicle price, availability, market conditions, vehicle pricing, special rates and discounts. The dealer or manufacturer is also able to choose a vehicle manually based on their own reasoning if they so desire 220.

In one embodiment, promotional offers and specials are created based on the optimal vehicle or vehicles selected. The process of creating a promotional offer 240 varies based upon the type of offer being created. Examples of the types of promotional offers a dealer or manufacturer may offer include, without limitation, finance payment, balloon payment, lease payment, buy, finance, rebate, and discount specials. In each case, disclaimers, expiration date, stock number, and other relevant details may be compiled with the special according to the manufacturer's disclaimer, local rules and regulations, and dealer/manufacturer specific wording.

The process, according to one embodiment, of creating a discount special comprises instructing the processor to determine, from the pricing data, the difference between the manufacturer's suggested retail price (“MSRP”) and the sale price offered for a vehicle including rebates from the manufacturer based on the dealer configuration.

The process of creating a rebate special, according to one embodiment, comprises instructing the processor to determine the maximum combination of the included rebates based on the configuration and the vehicle selected.

The process of creating a finance special, according to one embodiment, comprises instructing the processor to find the lowest available interest rates available for the selected vehicle. The processor searches a database or service for these available interest rates based on a list of requirements including, but not limited to, vehicle selected, region, lending institution, and available credit tier. The results of this search are used to determine the lowest available interest rate available on this vehicle for the respective terms. This information is then compiled into a headline or phrase highlighting the available rate and terms that it is available for and optionally can include other rates that are available for the vehicle at other terms.

The process of creating a buy special, according to one embodiment, comprises instructing the processor to determine the sale price offered for a vehicle including rebates from the manufacturer based on the dealer configuration.

The process, according to one embodiment, of creating a lease payment special comprises instructing the processor to calculate a lease payment based on the dealer configuration for the selected vehicle. The processor searches a database or service for available factors included in a lease such as the money factor, residual value, lease acquisition fee, lease rebates and purchase rebates. In one aspect, the processor converts the sale price in the feed from a purchase price to a lease price by optionally adding the purchase rebates and incentives on this vehicle back to the sale price and then subtracting the lease specific incentives and rebates from the price. In another aspect, the sale price is used to calculate the lease directly. Once the applicable lease factors have been gathered, the formula used to calculate a lease is common knowledge. The lease may be configured using smart defaults or based on the configuration specified by the dealer or manufacturer. In one aspect, standard lease settings are used, such as 36 months and 12,000 miles per year. In another aspect, the special is determined by running a variety of different payment scenarios and using the optimal payment based on a variety of measurements like lowest payment or most profitable scenario. The lease payment and applicable “due at signing” details are then compiled and a textual headline or title is generated describing the lease that was run. Details, such as if a security deposit is required, credit qualifications, and relevant fees, may be included in the disclaimer depending upon the configuration of the specials.

The process of creating a balloon payment special, according to one embodiment, is substantially the same process as creating a lease special, however the formula, interest rates, and relevant rebates and incentives would be applicable to a balloon payment instead of lease payment.

The process of creating a finance payment special, according to one embodiment, is substantially the same process as creating a lease special however the formula, interest rates, and relevant rebates and incentives would be applicable to finance payments instead of lease payments.

In embodiment of the invention, other types of promotional offers may also be generated, such as sign and drive specials, which are lease specials using a modified configuration from the normal lease configuration. This may apply to all specials types, and can vary based on the manufacturer or dealer specific current offers.

In order to determine the best available payment, according to one embodiment, vehicle pricing data is either brought in from a feed from other 3^{rd} party sources or may be pre-set in the tool. The system may determine which incentives are factored into that pricing and remove them before calculating any other type of payment. The system will then factor in incentives available for the applicable promotion before proceeding with the payment calculation.

The payment calculation, according to one embodiment, will determine the best mix of pricing data and incentive date to use by testing multiple scenarios that achieve the desired result. The system may monitor the compatibility of these incentives to ensure that they can be combined and are from the same source. The dealer's applicable fees and potential taxes, according to one embodiment, are also taken into account while calculating the payment amounts. In another aspect, the taxes and fees will be excluded from the pricing data and the exclusion will be reflected in the disclaimer.

Creation of the disclaimer 250, according to one embodiment, requires particular attention to comply with laws and original equipment manufacturer (“OEM”) advertising guidelines. In order to create the disclaimer, standard language may be extracted from the OEM advertisements to ensure compliance and accuracy with guidelines. This language might include mileage penalties, disposition or other turn-in fees, and other language regarding the terms of the lease with the manufacturer and bank. There may also be other standard language used in the disclaimer that is determined by the details of the special, including but not limited to, the total amounts due, mileage penalties, residual values, capitalized costs, selling price of the vehicle, stock numbers included, and the credit required to qualify for the special. Standard language may also be included per dealer or by the default SIC configuration. The details of the lease configuration, including but not limited to amounts due at signing and excluded fees may also be included in this disclosure.

In one embodiment, promotional offers may be dynamically generated and displayed 260 or may be stored 270 with certain triggers that allow the promotion to be rendered obsolete if new pricing data or incentive data, such as new rates, incentives, pricing, or inventory becomes available, thus ensuring that the offered promotions will remain current at all times. According to one embodiment of the invention, the customized image may be served from a display advertising server or other similar server. Prior to displaying a promotion, or according to preset periodic intervals, promotions, pricing data and incentive data are checked to make sure they are still current and that the information used to calculate the special has not changed. If a key value used to calculate that special has changed, the special will be deleted and a new special will be created. Currently offered specials also may be routinely monitored for their accuracy and completeness by a process to ensure that incentives, pricing, and inventory are current. Expired and non-current specials may be deleted and potentially recalculated using the new best data available.

According to one embodiment, specials may be stored in a database for later retrieval upon a triggering event. At the time the trigger occurs the processor may check the details used to calculate and generate the special against the database or service previously used to calculate the special to ensure that the information is still valid and the vehicle is still available. The processor may also compare the expiration date of the special and may automatically delete specials that have expired. The system may then regenerate missing specials according to the previously detailed methods.

In another aspect, specials may also be generated on demand by the nature of the requested special. The system may generate any of the available special types, discussed above, based upon the specified inputs and use that information to make the appropriate calculation and special configuration in real time.

In one embodiment, the Sales Manager may also have the ability to add custom specials to their specials feed, where they define the terms of the advertisement to be integrated into the Specials Image (“SI”). Alternatively, a custom special may be fed from a 3^{rd} party source to the Sales Manager for inclusion into the system. The system automatically determines if specials automatically created by the system are overridden by the custom special, and can delete automated specials if the custom special serves a similar purpose. Specials can also be hidden from view in the case that an automated special is not something that the dealer wants advertised to their clients.

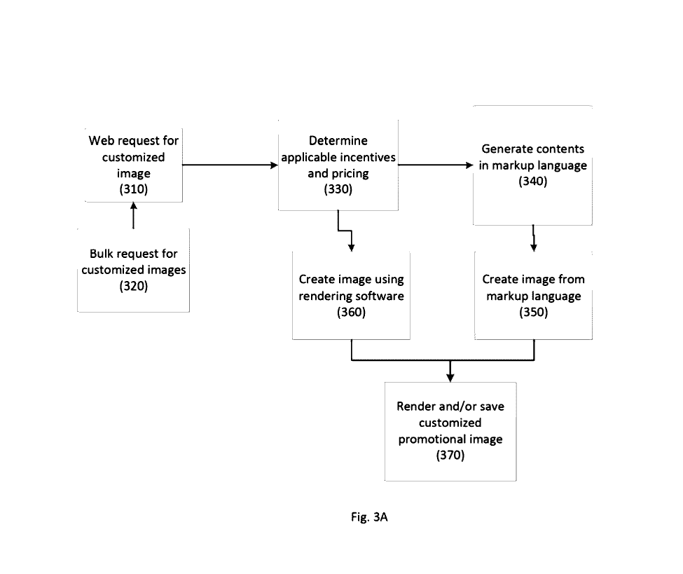

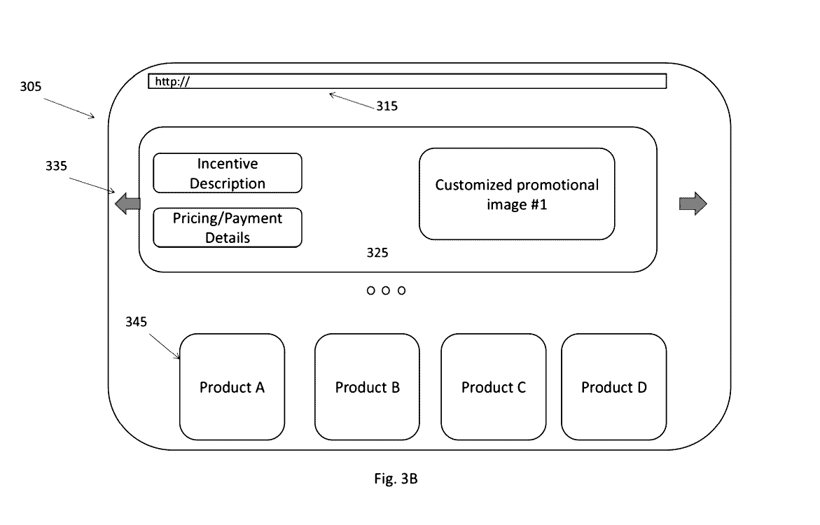

Another embodiment of the invention includes the dynamic and automatic creation of promotional images. FIG. 3 depicts a process flow 300 for image creation with one of the embodiments of the invention. According to one embodiment, a generation request is received for an SI 310 or bulk creation of SI's 320, whereby the system determines what type of special should be delivered in the SI 330, or, if no type is defined, determines what type of specials should be delivered based on available information in a pricing database. The pricing database, according to one embodiment, includes a repository of financial information and criteria required to generate a promotional offer. Non-limiting examples of pricing information include inventory, MSRP, interest rates, tax rates, fixed fees, and other financial inputs. The SIC then dynamically renders the image associated with the special or specials chosen. The image may contain, without limitation, one or more payments, one or more interest rate, and one or more sale prices, as well as an optional disclaimer for qualifying the terms of the advertisement.

In order to dynamically create the SI, according to an embodiment, the system first must determine which advertisements will be included and displayed in the image. The image displayed can be different depending upon which information, specials, and rates are available for that dealer's inventory and incentives. Upon determining the contents on the promotion, the system will choose from a variety of available templates, skins, formats and styles to change how the image will be formatted for display to the user.

One embodiment of this method involves rendering the special in HTML or other markup language 340, and then using a headless web browser to capture the rendered HTML or other markup language in the form of an image 350. This image may then be manipulated in multiple formats, including but not limited to, serving the image to a web browser based upon the URL of the request. The size, format, and other parameters used to make the image may be manipulated by the URL used to render the image 360. The request may also be cached so that similar requests for the same SI will be served without having to follow each step of the logic.

According to one embodiment, the system may generate a URL associated with the customized promotional image that, upon, activation of the URL, will direct the user to a relevant webpage associated with the dynamic content of the image. The relevant page may include additional information about the product, pricing or incentive depicted in the image. Further, an embodiment of the invention further includes the ability to dynamically, and automatically create, alter or update the URL to reflect any of the changes made to the customized image, such as update promotional information.

In one embodiment, images may be created using image rendering software 370 that offer a variety of tools including, but not limited to, applying image masks, combining image overlays, adding message contents and text through image manipulation software. The images created from the rendering software may then be rendered or saved as described above.

Since the contents of this image are dynamically created, according to one embodiment, a Special Link (“SL”) may also be created in conjunction with the image that determines where to direct the user for more details. The SL may include, but is not be limited to, a page with a full disclosure, the details of the payments, the details of the interest rate, inventory for the available vehicles, or a number of other relevant details. The SL may be called using a static URL that is coordinated with the SI URL. The redirection from this link may occur after the system determines what page or page contents should be displayed to the user after clicking on the SI or SL.

In one embodiment, the processor may capture and store the output from another embodiment and store that image using a caching method. The caching system is set by smart default or a specific configuration to expire at a time in the future. A system monitor may look for and detect changes in any of the content to be delivered. Upon finding an a change that would render the special stale or no longer available, the processor may expire the cached content so that the system will generate new requests for any content that has changed with the most current information available. This embodiment is designed to allow for more throughput with the same machine by reducing the resources necessary and time required to produce the content and images generated.

Turning now to FIG. 3B, an illustrative rendering of a customized image in a web browser is depicted. The illustrative web page 305 includes an address bar where the URL of the page is displayed. The web page 305 may be rendered via common markup languages such as HTML or another similar language used to create and present information via a browser. According to one embodiment, the web page 305 includes a scrolling or scrollable banner 335 that further includes one or more customized promotional images 325. Upon receiving a request to serve the webpage located at the URL in address bar 315, the system may dynamically generate the customized promotional image 325 by automatically by extracting the pricing data and incentive data from their respective databanks. The presentation of the data extracted from the databanks resembles a seamless image or series of images reflecting the pertinent details and requirements of the customized promotional offer. Below the banner, in one embodiment, the system may serve or include a plurality of various other offerings 345 of similar or like-kind products related to the product offered in the promotional offer. According to one embodiment, multiple customized images may be generated and presented to a consumer through the scrolling or scrollable banner 335, in which the banner may be advanced by clicking a directional arrow. Alternatively, the plurality of customized images may be automatically advanced according to a pre-set clock or periodic change cycle in which the proximate promotional image is loaded automatically.

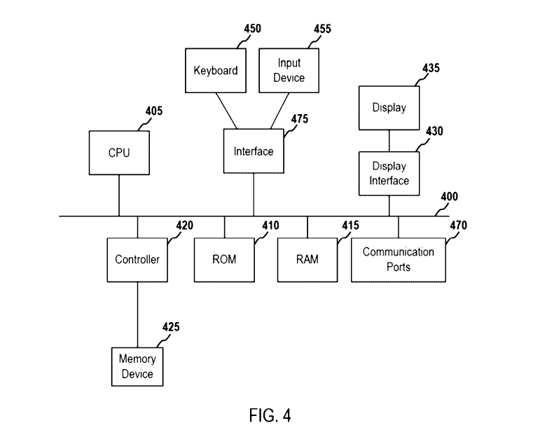

Turning now to FIG. 4 a block diagram of exemplary internal hardware that may be used to contain or implement the various computer processes and systems discussed above is depicted. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an exemplary processing device, computing device or processor as such terms are used within this disclosure. Read only memory (ROM) 430 and random access memory (RAM) 435 constitute exemplary memory devices.

A controller 420 interfaces with one or more optional memory devices 425 to the system bus 400. These memory devices 425 may include, for example, an external or internal DVD drive, a CD ROM drive, a hard drive, flash memory, a USB drive or the like. As indicated previously, these various drives and controllers are optional devices. Additionally, the memory devices 425 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with, among other things, analyzing a transport stream, inserting targeted content into a transport stream, and storing targeted data as described above may be stored in the ROM 430 and/or the RAM 435. Optionally, the program instructions may be stored on a tangible computer-readable medium such as a compact disk, a digital disk, flash memory, a memory card, a USB drive, an optical disc storage medium, such as a Blu-ray™ disc, on premise or cloud servers, and/or other recording medium.

An optional display interface 430 may permit information from the bus 400 to be displayed on the display 435 in audio, visual, graphic or alphanumeric format. The information may include information related to a current job ticket and associated tasks. Communication with external devices may occur using various communication ports 440. An exemplary communication port 440 may be attached to a communications network, such as the Internet or a local area network.

The hardware may also include an interface 445 which allows for receipt of data from input devices such as a keyboard 450 or other input device 455 such as a mouse, a joystick, a touch screen, a remote control, a pointing device, a video input device and/or an audio input device.

Computer program logic implementing all or part of the functionality previously described herein may be embodied in various forms, including, but in no way limited to, a source code form, a computer executable form, and various intermediate forms (for example, forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in a non-transitory form (for example, a source code form, a computer executable form, an intermediate form, or combinations thereof) in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink-wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Embodiments of the present invention provide numerous advantages over the traditional systems and processes of creating images for use in advertising. Examples of such advantages include, without limitation: higher accuracy as the inventive process creates and monitors specials without the need to human involvement; faster turnaround time from the release of new incentives and inventory to the creation of the image; and better compliance with rules and regulations from the automated disclosures. Further, embodiments of the present invention offer more thorough specials that may be created due to ability of the SIC to run many scenarios and more specials that may be created than in a traditional advertisement due to the work required to create each specials. Additionally, the present invention eliminates erroneous publication or dissemination of Expired Specials, Expired SI, or Specials created on vehicles that have previously been sold. According to one embodiment, the specials created through the inventive tool may be shared through multiple mediums synchronously.

According to one embodiment, templates may be used to reduce design costs as a dealer or manufacturer wants to theme their content. Additionally fewer system resources are used to generate dynamic images and specials due to the ability to recall and use of cached images previously created, vetted and confirmed to remain valid. Further less work is required to maintain specials as the system runs automatically.

Yet another advantage of embodiments of the present invention include the ability for other mediums to maintain the same source of image content month after month because the content delivered by that source is changed dynamically. This is in direct contrast to current systems in which new images need to be uploaded to the server every time it changes.

It will be appreciated that the above-described methods and procedures may be provided using the systems disclosed herein, or on other types of systems. The methods and procedures, unless expressly limited, are not intended to be read to require particular actors or systems performing particular elements of the methods.

In the preceding specification, the present invention has been described with reference to specific example embodiments thereof. It will, however, be evident that various modifications and changes may be made thereunto without departing from the broader spirit and scope of the present invention. The description and drawings are accordingly to be regarded in an illustrative rather than restrictive sense.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the invention.

What is claimed is:

1. A system for dynamically generating a customized image file to promote a product, the system comprising:
a processor;
an image database;
a pricing databank;
an incentive databank;
a promotional database comprising a plurality of promotional templates; and
a non-transitory, computer-readable storage medium in operable communication with the processor, wherein the computer-readable storage medium contains one or more programming instructions that, when executed, cause the processor to:
generate request for at least one customized image;
select a promotional template from the promotional database, the promotional template comprising input criteria for determination of an automated promotional offer;
extract promotional data from at least one of the pricing databank or the incentive databank;
inputting the promotional data into the input criteria of the promotional template;
generate the automated promotional offer, the automated promotional offer reflecting the promotional data extracted from the at least one of the pricing databank or the incentive databank;
retrieve at least one original image from the image database according to the promotional data; and
render the customized image from the original image and the automated promotional offer into a format for display in a web browser, the customized image reflecting the automated promotional offer.

2. The system of claim 1 wherein the promotional data comprises pricing information selected from the group consisting of: inventory, MSRP, sale price, interest rate, taxes, fees, calculated payment, mileage fees, and disclaimer information.

3. The system of claim 1 wherein the promotional template comprises a finance special.

4. The system of claim 3 wherein the processor is further configured to dynamically determine a best offer for the product.

5. The system of claim 4 wherein the best offer is selected from the group consisting of: a lowest interest rate, a lowest payment, lowest price, shortest term, lowest initial payment, and lowest tax.

6. The system of claim 1 wherein the promotional offer template is selected from the group consisting of: an optimal vehicle, finance special, lease special, rebate special, discount special, lease payment amount, purchase payment amount, balloon payment amount, and sign-and-drive special.

7. The system of claim 1 wherein the pricing databank comprises pricing information retrieved from a third party.

8. The system of claim 1 wherein the automated promotional offer comprises a disclaimer.

9. The system of claim 8 wherein the programming instructions cause the processor to dynamically generate the disclaimer from the promotional data.

10. The system of claim 1 where in the programming instructions cause the processor to detect a change in the promotional data.

11. The system of claim 10 wherein the programming instructions cause the processor to dynamically update the customized image according to the detected change in promotional data.

12. The system of claim 1 wherein the programming instructions cause the processor to periodically poll the pricing databank and the incentive databank for the change in promotional data.

13. The system of claim 1 wherein the programming instructions cause the processor to generate a uniform resource locator associated with the customized image, the uniform resource locator comprising a location of additional promotional data.

14. The system of claim 13 wherein the programming instructions update the uniform resource locator based upon a detected change in the promotional information.

15. The system of claim 1 wherein the programmable instruction further cause the processor to:
receive a custom promotional offer input through a user interface;
extract custom pricing data and custom incentive data from the custom promotional offer;
determine a best promotional offer between the custom promotional offer and the automated promotional offer; and
render the customized image from the original image and the custom promotional offer if the custom promotional offer is determined to be the best promotional offer.

16. A method for dynamically generating a customized image file to promote a product, the method comprising:
generating a request for at least one customized image;
selecting a promotional template from a promotional database, the promotional template comprising input criteria for determination of an automated promotional offer;
extracting promotional data from at least one of a pricing databank or an incentive databank;
inputting the promotional data into the input criteria of the promotional template;
generating the automated promotional offer, the automated promotional offer reflecting the promotional data extracted from the at least one of the pricing databank or the incentive databank;
retrieving at least one original image from an image database according to the promotional data; and
rendering the customized image from the original image and the automated promotional offer into a format for display in a web browser, the customized image reflecting the automated promotional offer.

17. The method of claim 16 wherein the promotional data comprises pricing information selected from the group consisting of: inventory, MSRP, sale price, interest rate, taxes, fees, calculated payment, mileage fees, and disclaimer information.

18. The method of claim 16 wherein the promotional offer template is selected from the group consisting of: an optimal vehicle, finance special, lease special, rebate special, discount special, lease payment amount, purchase payment amount, balloon payment amount, and sign-and-drive special.

19. The method of claim 16 wherein the automated promotional offer comprises a disclaimer.

20. The method of claim 19 further comprising dynamically generating the disclaimer from the promotional data.

21. The method of claim 16 further comprising detecting a change in the promotional data.

22. The system of claim 21 further comprising dynamically updating the customized image according to the detected change in promotional data.

23. A non-transitory computer-readable storage medium having computer-readable program code configured to generate a customized image file for promoting a product, the computer-readable program code comprising:
computer-readable program code configured to generate a request for at least one customized image;
computer-readable program code configured to select a promotional template from a promotional database, the promotional template comprising input criteria for determination of an automated promotional offer;
computer-readable program code configured to extract promotional data from at least one of a pricing databank or an incentive databank;
computer-readable program code configured to input the promotional data into the input criteria of the promotional template;
computer-readable program code configured to generate the automated promotional offer, the automated promotional offer reflecting the promotional data extracted from the at least one of the pricing databank or the incentive databank;
computer-readable program code configured to retrieve at least one original image from an image database according to the promotional data; and
computer-readable program code configured to render the customized image from the original image and the automated promotional offer into a format for display in a web browser, the customized image reflecting the automated promotional offer.
